(19) United States
(12) Patent Application Publication
(10) Pub. No.: US 2026/0023585 A1
(43) Pub. Date: Jan. 22, 2026

(54) SYSTEMS AND METHODS FOR VIRTUAL MACHINE PLACEMENT WITH ASYNCHRONOUS AND SYNCHRONOUS STAGES

(71) Applicant: Akamai Technologies, Inc., Cambridge, MA (US)

(72) Inventors: Atalay Kutlay, Cambridge, MA (US); Arun Sridharan, Cambridge, MA (US)

(21) Appl. No.: 18/774,672

(22) Filed: Jul. 16, 2024

(51) Int. Cl. G06F 9/455

(52) U.S. Cl. CPC G06F 9/45558; G06F 2009/4557

(57) ABSTRACT

Improvements in allocating virtual machines (VMs) to hosts can be accomplished using an approach that includes dual stages: both an asynchronous process and a synchronous process. The asynchronous process can be executed periodically based on current VM to host allocations, current hosts, and an expected set of VM requests in the future. The asynchronous process executes optimization algorithms to create allocation data for the synchronous process. The synchronous process actually fields requests for VMs and in response makes VM placement decisions. The allocation data is a constraint on the choices available to the synchronous process. But the synchronous process can override the allocation data and place the VM on a host that is “out of plan”, so even if the plan cannot be strictly followed for a given request, it will nevertheless succeed.

### BACKGROUND

### Technical Field

This patent document generally relates to virtualization of compute resources and to the allocation of virtual machines to hosts.

### Brief Description of the Related Art

In multitenant compute platforms, a tenant can request that the system create a virtual machine (VM) on-demand with certain characteristics. The platform places an appropriate VM on a particular physical host in an appropriate data center. This function is sometimes referred to as allocating the VMs to hosts. Customers may choose from a variety of different VM configurations in accord with their needs and desired cost. There may be a number of configurations to choose from, with each configuration being referred to as a VM type or “plan type”. For example, a VM may be offered with 128 GB of RAM, with dedicated or with shared CPUs.

It is important to allocate VMs to physical hosts in an efficient manner because the cost of physical machines and associated networking equipment is high. It is also important to satisfy a customer's request for a new VM promptly and with a host that is not overloaded.

Known ways of allocating VMs to physical hosts involve synchronously applying a ruleset that solves for a variety of requirements and the attributes of a requested VM (its associated plan type). There may also be constraints on where to place hosts, such as geographic or data center constraints, that must be taken into account.

In known solutions, VMs are allocated by walking through the rules, selecting a set of qualifying hosts, and then continuing to narrow the selection until a placement is made. Typically the rules are heuristics. The decisions are made in a synchronous fashion, as the requests arrive. The solution may involve identifying candidate hosts with enough capacity for the requested VM plan and ordering the candidate list in a certain way to increase packing efficiency.

Typically, system operators can manually configure the mixture of VM types in a set of hosts, setting for example a maximum percentage of each host's memory that is allowed for a given type of VM, so as to prevent a particular VM type from overwhelming the host. For example: for a given type of host (Host_1) with a given amount of RAM, the settings might indicate that up to 50% of the host (by RAM) may allocated to VMs of type 1, which each use 64 GB memory, while up to 25% of the host may be allocated VMs of type 2, which each use 128 GB memory, and so on.

This manual process is cumbersome and time consuming, and does not necessarily achieve an efficient packing of VMs into hosts, nor achieve desired results in light of future expectations for requests, maintenance, and usage spikes in the data center.

In the art of CDN request mapping and load balancing, it is known to perform offline (asynchronous) optimization and then deploy the results of such analysis into action (e.g., activating the DNS “map” that distributes requests to edge servers), see for example U.S. Pat. Nos. 6,430,618 and 6,108,703, the contents of which are hereby incorporated by reference. However, allocation of VMs is a different problem because VM requests may seek different amounts of resources (i.e., requests can be for different VM types, that is, for a different quantum of resources), and because the allocation is long-running and difficult to change. It is possible to migrate VMs from one host to another, but doing so is expensive, time-consuming, and disruptive. Also, it is important that VM requests can be filled efficiently both now and in the future (after the current request is fulfilled), especially given the long-running nature of the VMs—so the allocation must take into account long-range goals and potential states of the data center.

The teachings hereof present systems and methods for on-demand allocation of VMs to physical hosts in new and improved ways. The teachings presented herein improve the functioning of a computer system itself, maximizing the use of its resources, while also improvising the general functioning of a compute platform itself. Those skilled in the art will understand these and other improvements from the teachings hereof.

### BRIEF SUMMARY

This section describes some pertinent aspects of this invention. Those aspects are illustrative, not exhaustive, and they are not a definition of the invention. The claims of any issued patent define the scope of protection.

Improvements in allocating virtual machines (VMs) to hosts can be accomplished using an approach that includes dual stages: both an asynchronous process and a synchronous process. The asynchronous process can be executed periodically based on current VM to host allocations, current hosts, and an expected set of VM requests in the future. The asynchronous process executes optimization algorithms to create allocation data for the synchronous process. The synchronous process actually fields requests for VMs and in response makes VM placement decisions. The allocation data is a constraint on the choices available to the synchronous process. But the synchronous process can override the allocation data and place the VM on a host that is “out of plan”, so even if the plan cannot be strictly followed for a given request, it will nevertheless succeed.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a diagram illustrating an offline process for generating a plan for allocating virtual machines to hosts, in accordance with one embodiment of the teachings hereof;

FIG. 2 illustrates an example of allocation data produced by the offline process, and accordance with one embodiment of the teachings hereof;

FIG. 3 is a flow diagram illustrating generally how the offline process works, in accordance with one embodiment of the teachings hereof;

FIGS. 4A and 4B are illustrations of VM allocations in a set of four hosts as a result of two different approaches;

FIG. 5 is a diagram illustrating an offline process for generating a plan for migrating VMs, in accordance with one embodiment of the teachings hereof;

FIG. 6 is a diagram illustrating an offline process for generating a solution for a batch of VM requests, in accordance with one embodiment of the teachings hereof;

FIG. 7 is a diagram illustrating a system in which an offline process can generate allocation plans for various purposes, such as those shown in FIGS. 1, 5, and 6;

FIG. 8 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

Basic familiarity with well-known web page, streaming, and networking technologies and terms, such as HTML, URL, XML, AJAX, CSS, GraphQL, HTTP versions 1.1 and 2, HTTP over QUIC, MQTT, TCP/IP, and UDP, is assumed. Basic familiarity with well-known web page, streaming, and networking technologies and terms, such as virtual machine (VM), hypervisor, host, random access memory RAM, central processing unit (CPU), and so on, is assumed.

All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software.

### Overview

Improvements in allocating VMs to hosts can be accomplished using an approach that includes dual stages: both an asynchronous process and a synchronous process. The asynchronous process can be executed periodically based on current VM to host allocations, current hosts, and an expected set of VM requests in the future. Preferably, the asynchronous process periodically (e.g., after each period (T)). It can use the past history of requests (during T−1) as a prediction of the requests that are expected to arrive in the next time period (T+1). Past requests over a larger time period can also be analyzed to produce an expected set of requests using known statistical methods.

In this context a request for a VM is triggered by a customer's request to create a VM of some type. The type can be associated with attributes such as the size of memory it will have (e.g., RAM size), and/or the processing resources it will have (e.g., dedicated CPUs, shared CPUs, number of CPUs), e.g., a VM with 64 GB RAM and shared CPU. A request for a VM may also have constraints (e.g., should be placed in a separate rack from a customer's other VMs, etc.).

Preferably, the asynchronous process solves a multi-dimensional optimization problem to create allocation data. The allocation data, examples of which are described in more detail below, can be used by the synchronous process in the next stage. Preferably the allocation data indicates a desired mix of VM types on each host. Put another way, the allocation data can indicate which hosts the synchronous process can use when placing a given type of VM.

Known optimization algorithms such as mixed-integer linear programming models, as modified by the teachings hereof, can be used to generate the allocation data. The allocation data accounts for a variety of factors, as will be described below. The optimization of the objective function can be configured to target a certain end state. That is, if the allocation data is followed, then afterwards the data center's hosts will be in a state that is desirable not only for efficiently packing VMs during time period T+1, but also useful going forward later on in meeting some goal later on (typically, but exclusively, the goal is to be able to meet the next set of requests in the next period(s)). Such a long range planning capability can be helpful, for example, to maximize the number of different VM types that can be accommodated in the future by the data center, or maximize the room to place a particular VM type in the future. It is also useful when a known event will occur in the future such as a maintenance of hosts or a large set of VM requests due to a new customer or online event.

The asynchronous process provides the allocation data to the synchronous process. The synchronous process actually fields requests for VMs and in response makes VM placement decisions, based for example on the real-time status of the hosts. This synchronous process is sometimes referred to herein as the “online” stage, whereas the asynchronous process is referred to as the “offline” stage.

As mentioned, the synchronous process makes allocation decisions as requests arrive. It looks at an arriving request and decides where it can be placed, using known techniques and rulesets (e.g., making prioritizations based on host availability, capacity, and load), but as modified by the teachings hereof to take into account the allocation data.

As mentioned, preferably the allocation data is a soft-constraint on the choices available to the synchronous logic. It represents an “allocation plan” that is preferred by the asynchronous process. As such, the synchronous process can override the allocation data and place the VM on a host despite the allocation data indicating otherwise. So, even if the allocation plan cannot be strictly followed, a request for a VM will succeed.

With the foregoing by way of non-limiting overview, additional embodiments are now described in greater detail. (In the following description of embodiments, the “offline process” refers to the asynchronous process and the offline stage, as described above. The “online allocator” refers to the synchronous process and online stage, as described above.)

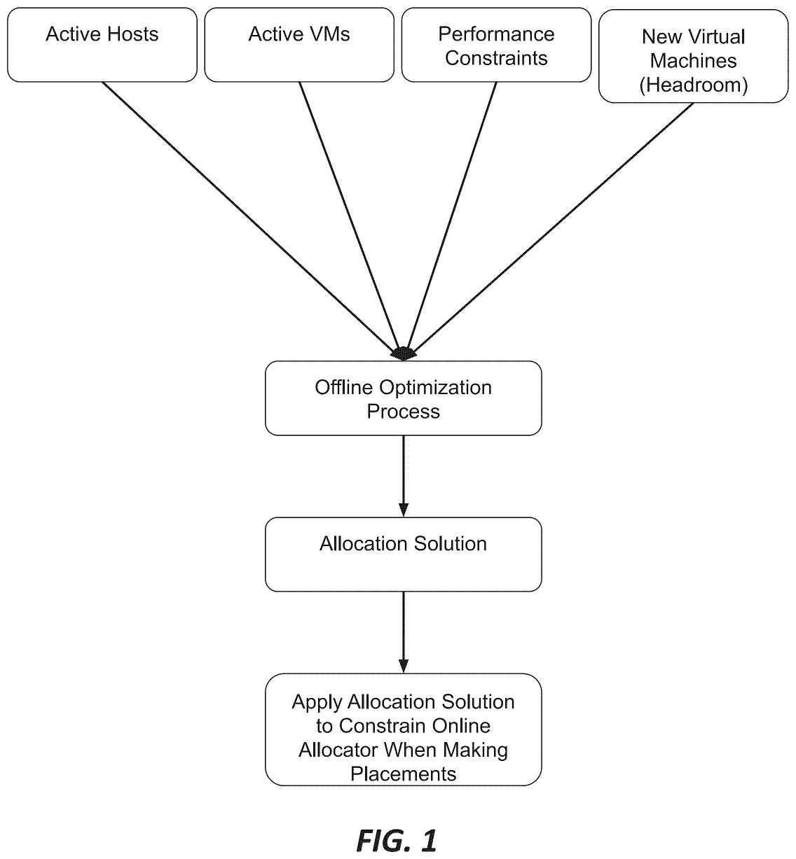

FIG. 1 is a high level diagram illustrating an offline process for placing VMs. The offline process is applied in a platform that contains on-demand compute resources in data centers around the world. The compute resources are physical machines (physical servers) that can be partitioned into VMs for the users of the platform. The servers are called hosts. A user can choose amongst several VM types that the platform offers, such as a shared CPU type, in which CPU resources are shared with other VMs on the host; a dedicated CPU type, and various sizes of RAM. A bare metal option (entire server) may be offered.

When a user requests the creation of a new VM, the platform must pick a host in a requested data center to place it. In order to satisfy the performance requirements of the requested VM, the host needs to have sufficient free resources.

In FIG. 1, an offline process is used to create a solution for VM allocation. It takes as input information about the active hosts, the active VMs, performance constraints and/or minimums, and the expected new VM requests. The information about active hosts includes such things as the capacities of each host (e.g., the amount of RAM memory, the number of CPUs, I/O characteristics, and the like), both in terms of maximum capacity and how much is currently being used. The offline process results in a recommended allocation for new VMs in the headroom available on the hosts, preferably keeping the current allocations static. Depending on the inputs and desired goals, the allocation solution can provide a solution that minimizes or limits the rejected VMs requests in the headroom and maximizes or increases the future availability to handle more placements (overall, or of a particular VM type), or to handle other data center events.

In one embodiment, the offline process uses a mixed integer linear program to produce an allocation plan. As known in the art, a mixed integer linear program is a kind of optimization algorithm that provides a solution for an objective function. In this implementation, the mixed integer linear program accepts the current allocations (the active VMs and hosts) and expected new requests for each VM type. Keeping the current allocation frozen, it creates a plan for allocating new VMs into the hosts. The solution of the mixed integer linear program provides a desirable target mapping of VMs to hosts. The solution is used to direct the online allocator (the synchronous process) to perform a more efficient packing. This can be accomplished by taking the solution of the mixed integer linear program and producing allocation data in the form of assigning caps to each host for each type of VM. This drives the online allocator's operation.

Subsequent to the offline process creating its solution, the online allocator makes the actual decisions on placement as requests arrive. As mentioned in the Background, it is known in the art to synchronously apply a ruleset that solves for a variety of requirements (real time status and health of hosts, etc.) and the attributes of a requested VM as well as preferences about placement on hosts (e.g. prefer host with most free memory, etc.). That is the job of the online allocator. However, in accord with the teachings hereof, the operation of the online allocator is modified by the solution given by the offline process. The solution is given in the form of allocation data.

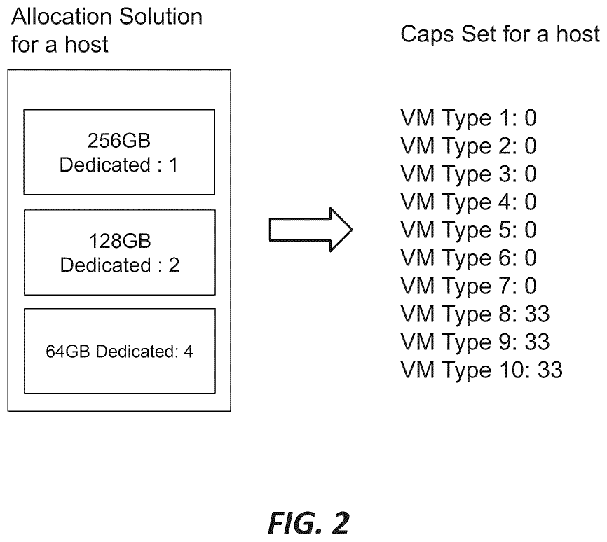

FIG. 2 illustrates an example of the allocation data produced by the offline process. On the left is a solution produced by the mixed integer linear program for one host. On the right are the caps, or limits, for that host in terms of percentages. In the example shown in FIG. 2, the solution involves allocating 4 of 64 GB dedicated, 2 of 128 GB dedicated and 1 of 256 GB dedicated VMs to the host. Therefore, the corresponding caps for this host would be (4*64)/768=˜0.33 for VM type 8 (assuming, e.g., type 8 corresponds to 64 GB dedicated plans) and (2*128)/758=˜0.33 for VM type 9 (assuming, e.g., type 9 corresponds to 128 GB dedicated plans) and 256/758=˜0.33 for VM type 10 (assuming, e.g., type 10 corresponds to 256 GB dedicated plans). FIG. 2 illustrates the allocation solution for one host, but in practice there are several hosts (e.g., in a data center). Each host would get its own allocation solution and own data specifying caps in a manner similar to FIG. 2, which of course may vary across hosts.

Given this solution, for a request for a VM of a given type, the online allocator can use the allocation data as a soft constraint.

For example, given the requested VM, the online allocator can first look for the hosts that have enough room within the assigned caps. If the host has enough room, then the priority is set to 1 (meaning the host has room for the slot), if not the priority is set to 0 (meaning the allocation solution did not allocate room for this VM type for the given host). Ordering host candidates for placing the VM by this priority number in a descending matter gives the online allocator the ability to follow the solution. When there is no host with priority=1, the online allocator still has other options with priority=0, therefore the solution is not strictly enforced, it is rather a soft constraint, or a recommendation, to the online allocator.

As a second example, the online allocator does not see assigned caps. Rather the allocation data from the offline process is in the form of an ordered priority list for each type of VM. When the given request is received, the online allocator simply walks down the list for that type of VM, placing it in the first host that has room. The hosts that are not preferred by the allocation solution are listed at the bottom of the list. So if the online allocator reaches those hosts, it may place the requested VM in one of them.

A third example involves the offline process specifying which hosts are subject to the allocation plan, and which are not. The online allocator receives a request for a given type of VM, and it first tries to fit the VM into hosts in accord with their plan, but if they do not have room, the online allocator can move to the “pool” of hosts that can be filled regardless of the plan. In this approach, there is a set of hosts that are packed in accord with a plan, and a set of “overflow” hosts that the online allocator can use as needed, if they have capacity.

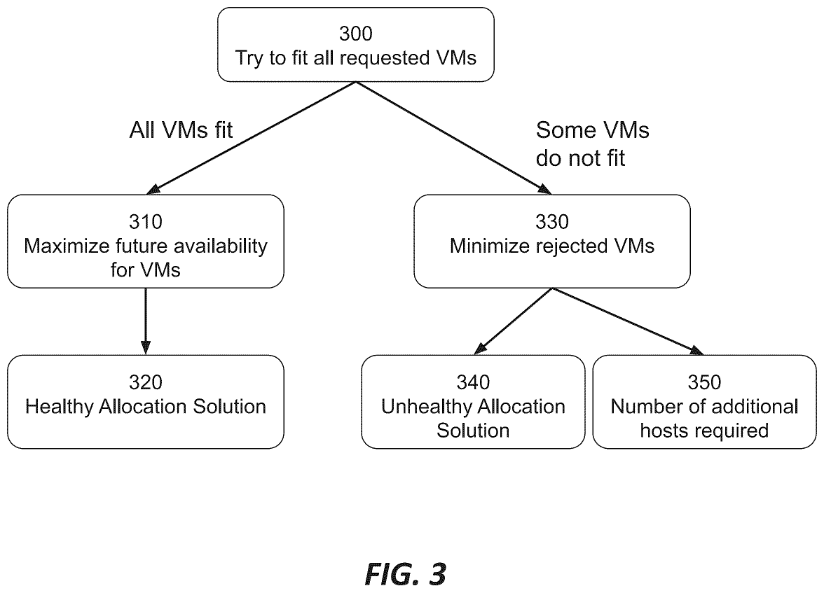

FIG. 3 illustrates at a general level how the offline process works in one embodiment. At 300, the process attempts to fit all requested VMs into the hosts (that is, the VMs that are expected to be requested in the time period for which the solution is valid). AS mentioned, this packing is subject to host resources, performance constraints such as CPU oversubscription, the number of VMs on a given host, and the like).

If all the VMs can fit, then at 310 the process attempts to increase or maximize the future availability for VMs. This analysis can take into account the VM types (e.g,. a certain type of VM may be preferred because it is more popular, a new customer might be expected to use it heavily, the revenue associated with the VM type is desirable, etc.). Then at 320, the allocation solution is produced with a healthy headroom.

If some of the VMs will not fit into the hosts, then at 330 the process attempts to reduce or minimize the rejected VMs. This analysis can take into account factors such as customer, number of rejected VMs, revenue or type of VMs, and so on. Then at 340 the allocation solution is produced, but it is considered unhealthy because there were rejected VMs. So at the same time, at 350 the process produces an alert, message, or recommendation for an additional number of hosts that should be added to the data center.

In one embodiment, an additional requirement (constraint) is that all of the virtual CPUs of a customer's VM fit into a single socket (physical CPU socket) in a multi-CPU computer. Generalizing, any resource constraint that could be enforced in an online allocator can also be incorporated as a constraint in the offline process' calculation of its allocation solution.

As mentioned, the offline process can leverage an optimization algorithm in the form of a mixed integer linear program, which is executed to mathematically optimize an objective function. One example of an objective function is as follows:

$${min}_{V ( {h}_{i} , {s}_{i} )} N \times ( {\sum }_{{s}_{i} ∈ S} P ( {s}_{i} ) \cdot {Cs}_{i} ) - {\sum }_{{h}_{i} ∈ H} {\sum }_{{s}_{i} ∈ {S}_{A}} A ( {h}_{i} , {s}_{i} ) \cdot {Cs}_{i} \cdot {Ws}_{i}$$

where V(hᵢ, sᵢ) is the headroom assignment of service sᵢ to host hᵢ
Csᵢ is the revenue from service sᵢ
Ahᵢ, is the availability of service sᵢ in host hᵢ
P(sᵢ) is the unmet headroom for service sᵢ
Wsᵢ is the weight assigned to service sᵢ
N is a constant that is sufficiently large such that the left side (positive side) of the function is substantially larger than the right side (negative side); for example N=10,000.

It should be noted that the solution produced by the offline process can be used to provide several different capabilities. It can provide the ability to fit new VMs given a state of the data center, the ability to prioritize the availability of certain VM types, and/or the ability to plan and constrain allocations in view of future performance requirements. It also is possible to run the offline process and its model independently for each data center. Typically the model would be expected to run, e.g., 1-5 seconds for small or medium data centers, possibly 10-30 seconds for large data centers. The model can be run periodically, e.g., every hour, to produce an updated allocation solution for the next time period. Hence the allocation solution is valid for a limited time period, after which it is rerun with updated information such as the current state of the hosts, a new set of expected requests taking into account the requests from the past hours, and so on.

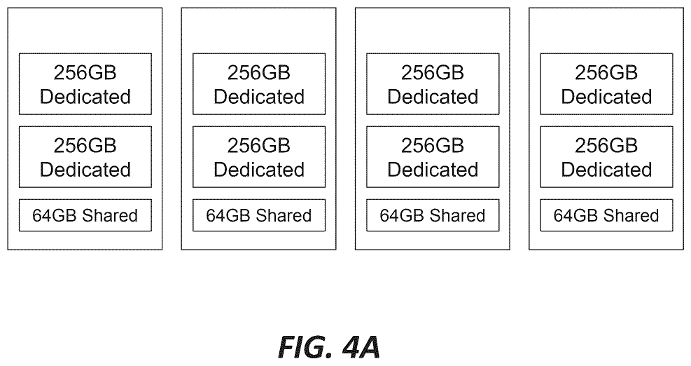

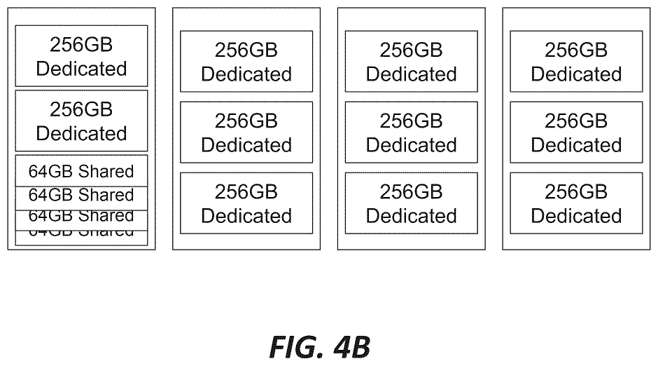

FIGS. 4A and 4B are an illustration of how the offline process can improve allocations. FIG. 4A shows a possible packing example where each VM is placed one at a time using a ruleset. FIG. 4B is a packing example that can be achieved using the offline process and modeling. The offline process is able to better place the shared resources (shared CPU plans) on a single host. This depends on knowing the expected demand for VMs in advance (e.g., that there will be 4×64 GB plans requested). However, observing past request streams and statistically predicting expected future requests can be done using a wide variety of known algorithms, such as a least squares regression, autoregressive integrated moving average, or otherwise, depending on the desired method of consumption.

### Uses of Allocation Solution

In the examples above, the allocation solution was deployed as a soft-control for the online allocator to make placement decisions, as shown in FIG. 1. It could be used as a hard-control (absolute limit) as well. Further, it should be understood that the allocation solutions can be used for many purposes.

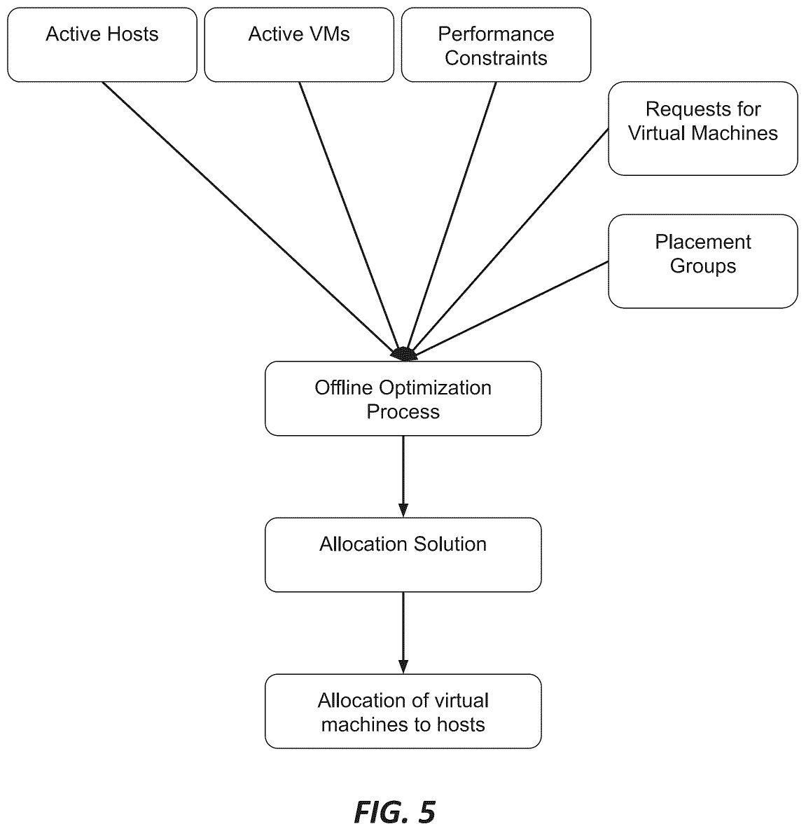

Another use is to provide offline rebalancing, that is to use the solution to produce a VM migration plan to improve the distribution and availability of headroom on the hosts. In this use case, the allocation solution is run and compared to the current state, then a number (preferably minimized) of VMs are selected for migration so that the state of the hosts transitions towards the allocation solution. FIG. 5 is a variant of FIG. 1 that illustrates usage for the migration case.

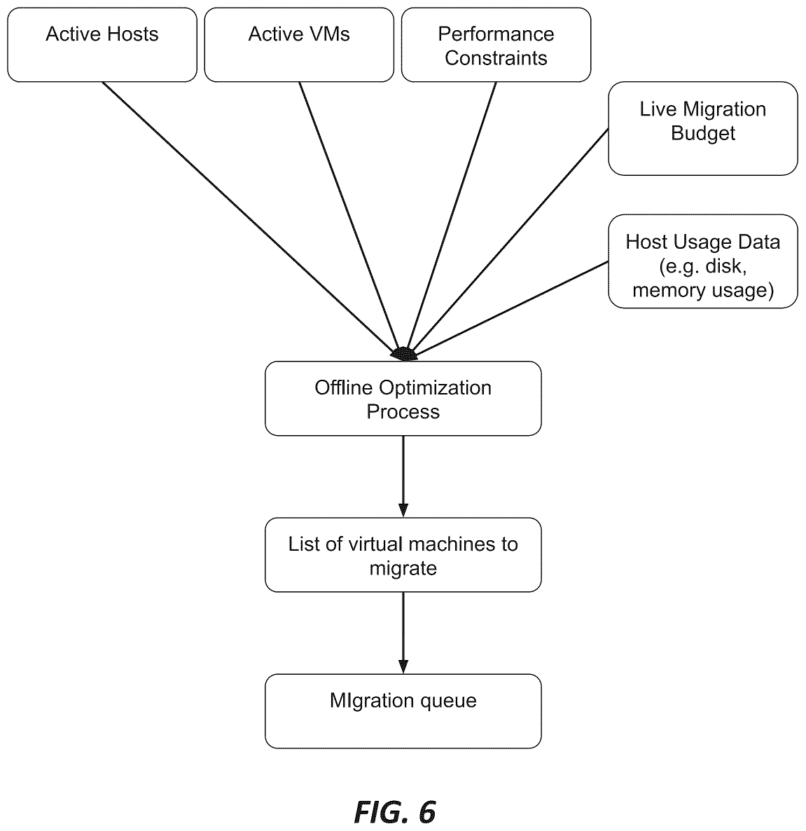

Another use is to perform on-demand batch allocations (e.g., in advance of an anticipated online event). This means the model is used to identify and create preferred destination hosts for a batch of allocation requests that are expected to arrive. FIG. 6 is a variant of FIG. 1 that illustrates this use.

In FIG. 6, the offline process can take a migration budget in the form of a maximum number of migrations, to constraint the solution for the batch. To implement this constraint, a variable can be introduced to track the difference between the initial allocation and the resulting allocation (proposed solution) for each <host id, service> pair. The difference therefore indicates how much migration is necessary to reach the solution. More specifically, in one implementation, the constraint limits the sum of absolute value of the difference between initial and resulting allocations, divided by 2. So, for example,

### Initial Allocation:

HostID 1, Service A: 5
HostID 2, Service B: 5

### Resulting Allocation (Proposed Solution):

HostID 1, Service A: 4
HostID 2 Service A: 1
HostID 2, Service B: 5

Therefore, there is a difference of −1 in HostID 1, Service A, and a difference of +1 in HostID 2 Service A. The total sum of absolute values of differences is 2, divided by 2, which gives the number of migrations. In producing a final allocation solution, this number of migrations must stay below the migration budget, and/or preferably is minimized.

Finally, the allocation solution can be used for platform management and operations, e.g., to answer questions about growth, deployment, and investment needed in a data center, or whether a new type of VM can be supported.

### System

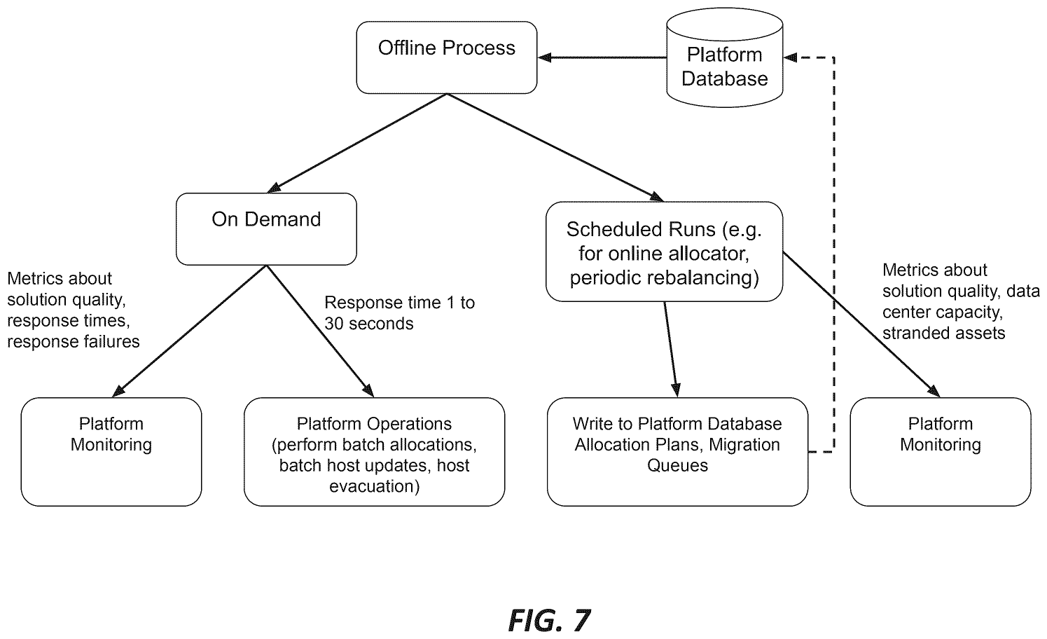

FIG. 7 illustrates a system for using the offline process' ability to allocate VMs to hosts. The results can be used on demand for platform operations (batch allocations, batch host updates, etc. migrations) as shown on the left hand side. The offline process can also be used in a scheduled run mode, e.g., to improve the online allocator operation, to perform periodic rebalancing. The platform database contains the current VM and host data, including the current allocations. After a scheduled run, the offline process solutions are written back to the platform database. The online allocator, for example, can read the allocation data from this database to understand the caps to use when it is making placement decisions. Other tools and utilities (including e.g., the platform operations shown in FIG. 7) also consult this database to understand what migration jobs must be performed, for example.

The offline process can be deployed as an optimization service. It can be built with a traditional API backed with multiple instances and load balancing. It can be built using kubernetes or other containerized technologies.

The model that the offline process optimizes and executes can be designed to run independently for each data center. Hence each datacenter in a larger platform can have its own process running with a view (inputs) specific to that datacenter and producing a solution tailored to that datacenter as well.

### Safety/Security

The offline process preferably exposes quality signals so that automated and manual checks can be implemented. Model internal metrics such as objective function value, MIP gap (i.e., the difference between the theoretical lower bound and found lower bound, such as 5%), and pre-solve/model solve times can be exposed.

### Extension Beyond VMs

While the foregoing description has used VMs as an illustrative example, the teachings hereof apply likewise to the placement or allocation of any compute resource or instance across physical hosts.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

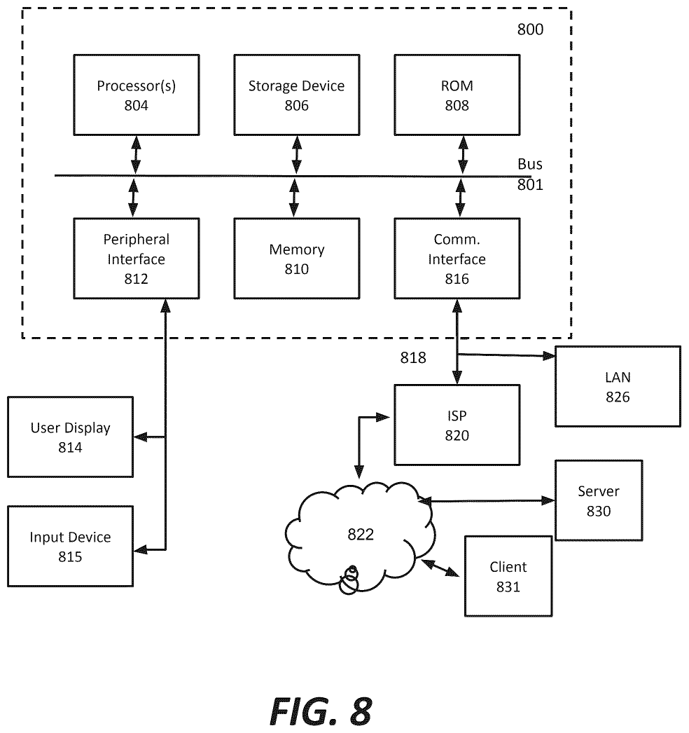

FIG. 8 is a block diagram that illustrates hardware in a computer system 800 upon which such software may run in order to implement embodiments of the invention. The computer system 800 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 800 includes a microprocessor 804 coupled to bus 801. In some systems, multiple processor and/or processor cores may be employed. Computer system 800 further includes a main memory 810, such as a random access memory (RAM) or other storage device, coupled to the bus 801 for storing information and instructions to be executed by processor 804. A read only memory (ROM) 808 is coupled to the bus 801 for storing information and instructions for processor 804. A non-volatile storage device 806, such as a magnetic disk, solid state memory (e.g., flash memory), or optical disk, is provided and coupled to bus 801 for storing information and instructions. Other application-specific integrated circuits (ASICs), field programmable gate arrays (FPGAs) or circuitry may be included in the computer system 800 to perform functions described herein.

A peripheral interface 812 may be provided to communicatively couple computer system 800 to a user display 814 that displays the output of software executing on the computer system, and an input device 815 (e.g., a keyboard, mouse, trackpad, touchscreen) that communicates user input and instructions to the computer system 800. However, in many embodiments, a computer system 800 may not have a user interface beyond a network port, e.g., in the case of a server in a rack. The peripheral interface 812 may include interface circuitry, control and/or level-shifting logic for local buses such as RS-485, Universal Serial Bus (USB), IEEE 1394, or other communication links.

Computer system 800 is coupled to a communication interface 816 that provides a link (e.g., at a physical layer, data link layer,) between the system bus 801 and an external communication link. The communication interface 816 provides a network link 818. The communication interface 816 may represent an Ethernet or other network interface card (NIC), a wireless interface, modem, an optical interface, or other kind of input/output interface.

Network link 818 provides data communication through one or more networks to other devices. Such devices include other computer systems that are part of a local area network (LAN) 826. Furthermore, the network link 818 provides a link, via an internet service provider (ISP) 820, to the Internet 822. In turn, the Internet 822 may provide a link to other computing systems such as a remote server 830 and/or a remote client 831. Network link 818 and such networks may transmit data using packet-switched, circuit-switched, or other data-transmission approaches.

In operation, the computer system 800 may implement the functionality described herein as a result of the processor executing code. Such code may be read from or stored on a non-transitory computer-readable medium, such as memory 810, ROM 808, or storage device 806. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 818 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method for allocating virtual machines to hosts, the method performed by at least one computer and comprising:
receiving, during a limited period of time, a plurality of requests to place virtual machines in one of a plurality of hosts, each requested virtual machine having one of a limited number of types;
with a first process executed asynchronous to receiving the plurality of requests:
generating allocation data for the plurality of hosts, the allocation data indicating how many of each virtual machine type should be run on each of the plurality of hosts,
the generation of allocation data comprising: applying an optimization algorithm to an objective function, the objective function taking a set of inputs that includes: (i) information about virtual machines already running on the plurality of hosts, and (ii) information indicating an expected set of requests for placing virtual machines that are expected to arrive during the limited period of time, with expected virtual machine types;
with a second process that receives the plurality of requests:
receiving the allocation data from the first process; and,
synchronous to receiving a given one of plurality of requests, selecting one of the plurality of hosts on which to place the requested virtual machine, where the second process initially attempts to adhere to the allocation data but overrides the allocation data if necessary to avoid rejecting the given one of the plurality of requests.

2. The method of claim 1, wherein the plurality of virtual machine types are characterized by at least one of the following:
random access memory (RAM) size,
central processing unit (CPU) attributes, and
input/output (I/O) attributes.

3. The method of claim 1, wherein the allocation data is valid for the limited period of time, after which the first process executes again to produce further allocation data for use in a subsequent period of time.

4. The method of claim 1, wherein the expected set of requests is derived from at least one of the following sources:
previously observed requests to place virtual machines, and
known future events that impact any of (a) availability and (b) load on the plurality of hosts.

5. The method of claim 1, the set of inputs to the objective function further including: (iii) information indicating a preference to have room available on the plurality of hosts, after the limited period of time, to place additional virtual machines of a certain type.

6. The method of claim 1, wherein the optimization algorithm comprises a mixed integer linear programming algorithm.

7. The method of claim 1, wherein the first process, in order to enable the second process to initially attempt to adhere to the allocation data but override the allocation data if necessary, specifies a first set of hosts to which allocation data applies, and a second set of hosts to which the allocation data does not apply, and the second process overrides the allocation data by selecting one of the plurality of hosts from the second set of hosts.

8. The method of claim 1, wherein the allocation data indicates an order in which the second process should consider the plurality of hosts when determining where to place the requested virtual machine.

9. A system comprising at least one computer with circuitry forming a memory for storing computer program instructions and at least one processor for executing said computer program instructions to cause the system to:
receive, during a limited period of time, a plurality of requests to place virtual machines in one of a plurality of hosts, each requested virtual machine having one of a limited number of types;
execute a first process executed asynchronous to receiving the plurality of requests, that:
generates allocation data for the plurality of hosts, the allocation data indicating how many of each virtual machine type should be run on each of the plurality of hosts,
the generation of allocation data comprising: applying an optimization algorithm to an objective function, the objective function taking a set of inputs that includes: (i) information about virtual machines already running on the plurality of hosts, and (ii) information indicating an expected set of requests for placing virtual machines that are expected to arrive during the limited period of time, with expected virtual machine types;
execute a second process that receives the plurality of requests, and that further:
receives the allocation data from the first process; and,
synchronous to receiving a given one of plurality of requests, selects one of the plurality of hosts on which to place the requested virtual machine, where the second process initially attempts to adhere to the allocation data but overrides the allocation data if necessary to avoid rejecting the given one of the plurality of requests.

10. The system of claim 9, wherein the plurality of virtual machine types are characterized by at least one of the following:
random access memory (RAM) size,
central processing unit (CPU) attributes, and
input/output (I/O) attributes.

11. The system of claim 9, wherein the allocation data is valid for the limited period of time, after which the system executes the first process again to produce further allocation data for use in a subsequent period of time.

12. The system of claim 9, wherein the system derives the expected set of requests from at least one of the following sources:
previously observed requests to place virtual machines, and
known future events that impact any of (a) availability and (b) load on the plurality of hosts.

13. The system of claim 9, the set of inputs to the objective function further including: (iii) information indicating a preference to have room available on the plurality of hosts, after the limited period of time, to place additional virtual machines of a certain type.

14. The system of claim 9, wherein the optimization algorithm comprises a mixed integer linear programming algorithm.

15. The system of claim 9, wherein the first process, in order to enable the second process to initially attempt to adhere to the allocation data but override the allocation data if necessary, specifies a first set of hosts to which allocation data applies, and a second set of hosts to which the allocation data does not apply, and the second process overrides the allocation data by selecting one of the plurality of hosts from the second set of hosts.

16. The system of claim 9, wherein the allocation data indicates an order in which the second process should consider the plurality of hosts when determining where to place the requested virtual machine.

17. Non-transitory computer readable medium comprising program code for execution one at least one hardware processor to cause at least one computer to perform steps comprising:
receiving, during a limited period of time, a plurality of requests to place virtual machines in one of a plurality of hosts, each requested virtual machine having one of a limited number of types;
with a first process executed asynchronous to receiving the plurality of requests:
generating allocation data for the plurality of hosts, the allocation data indicating how many of each virtual machine type should be run on each of the plurality of hosts,
the generation of allocation data comprising: applying an optimization algorithm to an objective function, the objective function taking a set of inputs that includes: (i) information about virtual machines already running on the plurality of hosts, and (ii) information indicating an expected set of requests for placing virtual machines that are expected to arrive during the limited period of time, with expected virtual machine types;
with a second process that receives the plurality of requests:
receiving the allocation data from the first process; and,
synchronous to receiving a given one of plurality of requests, selecting one of the plurality of hosts on which to place the requested virtual machine, where the second process initially attempts to adhere to the allocation data but overrides the allocation data if necessary to avoid rejecting the given one of the plurality of requests.
